(19) United States
(12) Patent Application Publication
(10) Pub. No.: US 2009/0300243 A1
(43) Pub. Date: Dec. 3, 2009

(54) TRANSMITTING AND CONVERSION APPARATUS FOR UNIVERSAL SERIAL BUS (USB) TO HIGH DEFINITION MULTIMEDIA INTERFACE (HDMI)

(75) Inventor: Cheng-Min Chao, Chung Ho City (TW)

Correspondence Address: LOWE HAUPTMAN HAM & BERNER, LLP, 1700 DIAGONAL ROAD, SUITE 300, ALEXANDRIA, VA, 22314, US

(73) Assignee: Grandtec Electronic Corporation, Taipei Hsien (TW)

(21) Appl. No.: 12/259,392

(22) Filed: Oct. 28, 2008

(30) Foreign Application Priority Data
May 29, 2008 (CH) 097209383

(51) Int. Cl. G06F 13/42

(52) U.S. Cl. 710/71

(57) ABSTRACT

A transmitting and conversion apparatus for universal serial bus (USB) to high definition multimedia interface (HDMI), comprises main body, at one end of the main body, there is a USB connection port, while there is a HDMI output port at the another end; in the main body, there is a USB interface, a USB Hub circuit, a USB to 12/24-bit RGB format output circuit, a USB audio signal conversion circuit, a HDMI conversion circuit and a micro-computer unit (MCU). By using the subject apparatus, the USB connection port can be connected to the interface port of a computer main frame, the computer main frame then outputs a USB packet video signal sequentially via USB Hub circuit, USB to 12/24-bit RGB format output circuit, USB audio signal conversion circuit, HDMI conversion circuit and convert the signal into signal of HDMI format, and finally, the signal of HDMI format is outputted via a HDMI output port for displaying.

### BACKGROUND OF THE INVENTION

1. Field of the Invention

The present invention relates to a transmitting and conversion apparatus for universal serial bus (USB) to high definition multimedia interface (HDMI), especially to a conversion apparatus which uses a USB connection port to connect a computer main frame, and then converts the USB video signal into a signal of HDMI format for outputting.

2. Description of Prior Art

A conventional conversion apparatus of USB to VGA is shown in Taiwan patent publication No. M240627, as shown in FIG. 3 it comprises a main body 100, a USB data processing circuit 110 having a USB port 130 and an interface converting device 120 for converting USB to VGA (Video Graphics Array), said USB port 130 is connected to a USB interface port 210 of computer main frame 200, so as to transmit control instruction and data to computer main frame 200 for performance, or to receive the USB packet sharing information and pictures display information outputted from computer main frame 200, and to convert the said USB packet pictures display information into a VGA pictures display information via a USB to VGA interface converting device 120; a keyboard 220, connects to a USB data processing circuit 110, to output and deliver control instruction and information to USB data processing circuit 110; a display panel 300, which is connected to said keyboard 220 and said USB to VGA interface converting device 120 of said USB data processing circuit 110, so as to receive the VGA pictures display signal outputted from USB to VGA interface converting device 120 and then to display pictures.

However, although said conventional USB to VGA conversion device can convert USB packet pictures display information into a VGA pictures display information and to output, the outputted VGA pictures display information only comprises pictures signal, people cannot hear the voices corresponding to said pictures. As a result, the version of said information outputted from computer main frame is not completely obtained and this is not convenient to people.

### SUMMARY OF THE INVENTION

In view of the above defects noticeable on the prior art, an improvement is seriously required. The inventor has dedicated great efforts for years to studying and improving these defects and come up with a novel transmitting and conversion apparatus for universal serial bus (USB) to high definition multimedia interface (HDMI) thereof as provided in this invention.

The object of present invention is to provide a transmitting and conversion apparatus for universal serial bus (USB) to high definition multimedia interface (HDMI), by which the USB connection port can be connected to the interface port of a computer frame, the computer then converts a USB packet video 1o signal into a signal of HDMI format, and outputs it via a HDMI output port. Such that the displayers display not only the pictures, but also the voices for people.

According to the object of present invention, the transmitting and conversion apparatus for universal serial bus (USB) to high definition multimedia interface (HDMI) of present invention includes a main body, on one end of the main body, there is a USB (universal serial bus) connection port, while on the another end, there is a HDMI (high definition multimedia interface) output port; in the main body, there is a USB interface, a USB Hub circuit, a USB to 12/24-bit RGB format output circuit, a USB audio signal conversion circuit, a HDMI conversion circuit and a micro-computer unit (MCU), wherein, the USB audio signal conversion circuit converts USB signal into 12S or S/PDIF voice signal, the HDMI conversion circuit is responsible for converting RGB format signals into HDMI TMDS signals, while the micro-computer unit (MCU) is responsible for controlling the user control registers data inside the HDMI conversion circuit, read the EDID (Extended Display Identification Data) in a television, and transmits the signal back to the computer controls software to determine the definition of output signals.

Wherein, the USB interface is connected with USB connection port and USB Hub circuit; the USB Hub circuit is connected simultaneously with USB to USB to 12/24-bit RGB format output circuit and USB audio signal conversion circuit; the USB to 12/24-bit RGB format output circuit, the USB audio signal conversion circuit then connect with HDMI conversion circuit; the micro-computer unit (MCU) is connected with HDMI conversion circuit by an I2C interface having a SDA and a SCL signal transmitting lines, so as to achieve the communication between two ICs; and is HDMI conversion circuit is connected to HDMI output port.

The output features of HDMI signal are as follows:
A. Bandwidth of video frequency and pixel code:

The bandwidth of video frequency of HDMI signal is from 25 MHz to 340 MHz (type A, HDMI 1.3) or to 680 MHz (type B); the 20 video signals having bandwidth lower than 25 MHz, such as NTSC 480i shall be outputted with the method of frequency multiplication.
B. The allowance amount of information of a pixel is from 24 bits to 48 bits, it supports the transmission of pictures having 120 frame 1080p definitions and WQSXGA definition [1].
C. The encodings of pixel are: RGB 4:4:4, YCbCr 4:4:4 (8-16 bits per component); YCbCr 4:2:2 (12 bits per component).
D. The rates of sampling audio frequency are: 32 KHz, 44.1 KHz, 48 KHz, 88.2 KHz, 96 KHz, 176.4 KHz, 192 KHz, characterized in that: by using only one HDMI cable, the voice and image can be simultaneously outputted on television.

Before using the present invention, the USB connection port is connected to USB interface port of computer main frame, then, through the software installed inside the computer, the image is converted into USB signal, and then the computer main frame outputs a USB packet video signal sequentially via USB Hub circuit, USB to 12/24-bit RGB format output circuit, USB audio signal conversion circuit, HDMI conversion circuit as a converted signal of HDMI format, as such, when a television of HDMI is connected to HDMI output port, then the television can display the voice and image signals of HDMI format. Then people can immediately understand the display version including voice and image, and, the audio and video signals have functions of multimedia and high definition.

A more complete understanding of these and other features and advantages of the present invention will become apparent from a careful consideration of the following detailed description of certain embodiments illustrated in the accompanying drawings.

### BRIEF DESCRIPTION OF THE DRAWINGS

FIG. 1 is a block diagram showing the circuit of transmitting and conversion apparatus for universal serial bus (USB) to high definition multimedia interface (HDMI) of present invention.

FIG. 2 is a diagram showing the present invention in using.

FIG. 3 is a diagram showing the prior art of transmitting and conversion apparatus for USB to VGA.

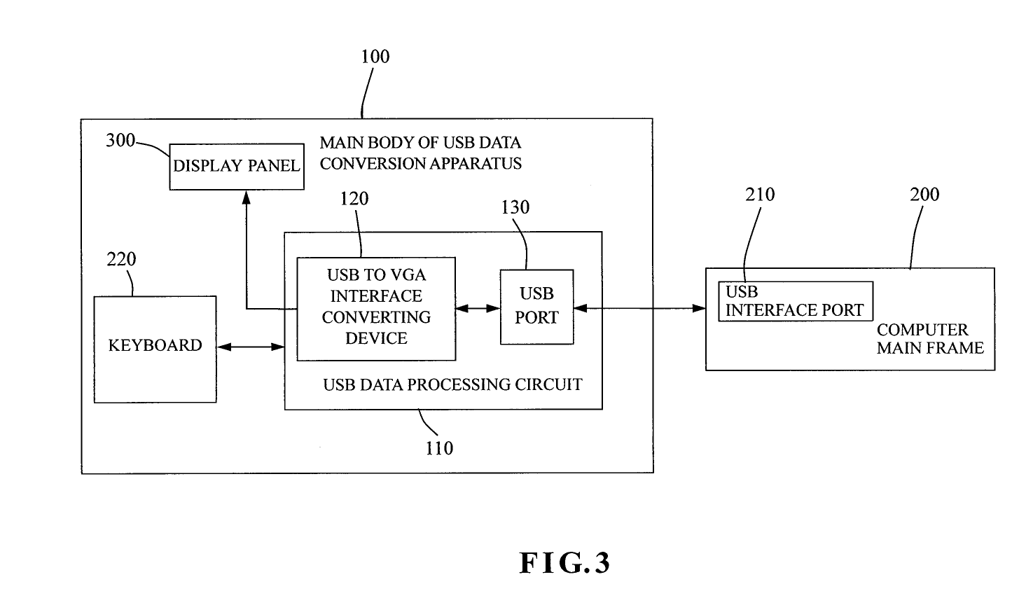

### DETAILED DESCRIPTION OF THE PREFERRED EMBODIMENTS

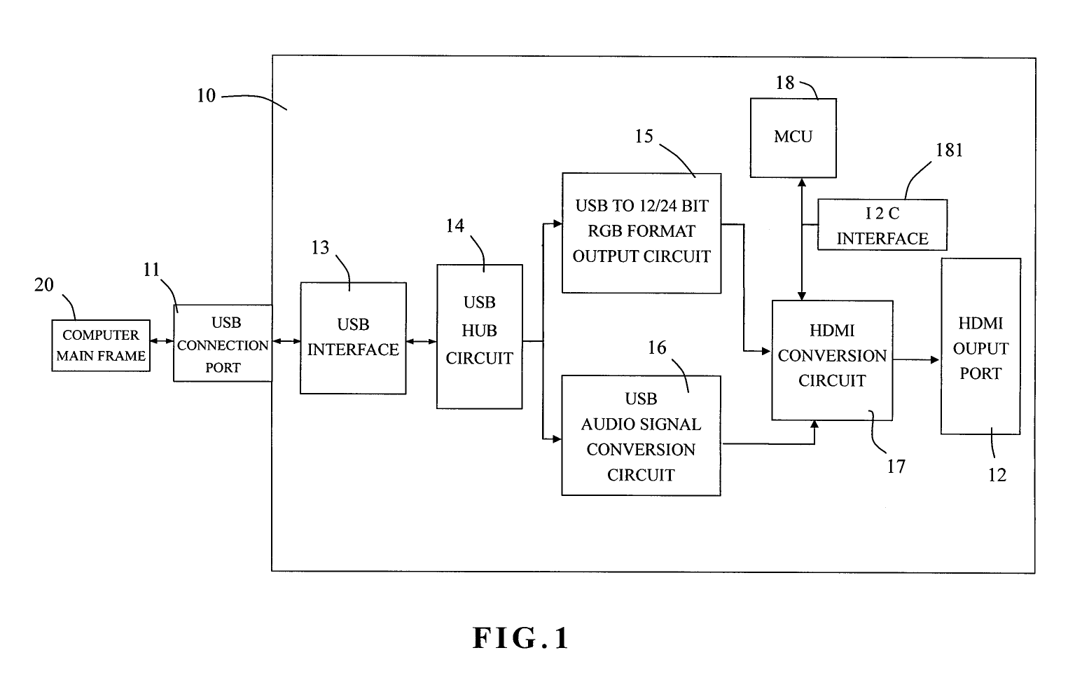

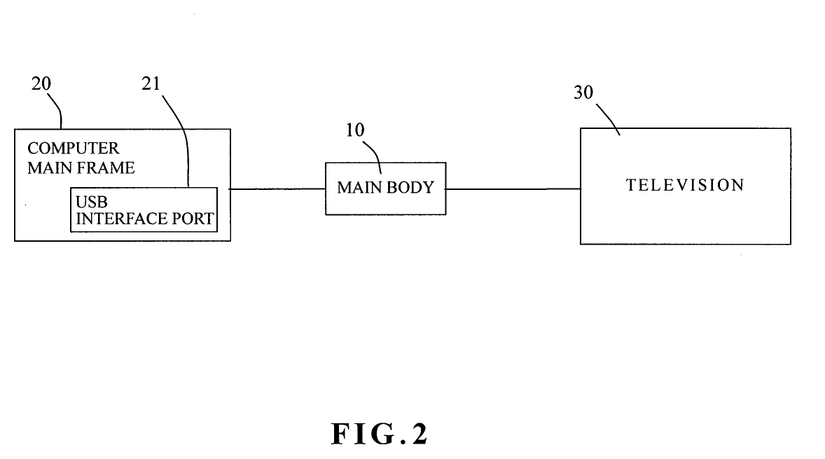

The present invention relates to a transmitting and conversion apparatus for universal serial bus (USB) to high definition multimedia interface (HDMI), please refer to FIGS. 1 and 2, the transmitting and conversion apparatus for universal serial bus (USB) to high definition multimedia interface (HDMI) of present invention is provided with a main body 10, on one end of the main body, there is a universal serial bus (USB) connection port 11, which is connected to a USB interface port 21 of computer main frame 20, the another end of main body 10 is installed with a high definition multimedia interface (HDMI) output port 12.

Inside the main body 10, there are provided with a USB interface 13, a USB Hub circuit 14, a USB to 12/24-bit RGB format output circuit 15, a USB audio signal conversion circuit 16, a HDMI conversion circuit 17 and a micro-computer unit (MCU) 18.

Said USB audio signal conversion circuit 16 is a digital transmission interface for converting USB signal format into S/PDIF or I2S format. Wherein, S/PDIF is Sony/Philips Digital Interface Format; the I2S is Inter-IC Sound or Integrated Interchip Sound: each of them is an interface standard of transmitting digital audio information between ICs, and each of them sequentially transmits two group informations of right and left audio channels.

As shown in FIG. 1, the USB interface 13 is connected with lo USB connection port 11 and USB Hub circuit 14; the USB Hub circuit 14 is connected simultaneously with USB to 12/24-bit RGB format output circuit 15 and USB audio signal conversion circuit 16; the USB to 12/24-bit RGB format output circuit 15 and USB audio signal conversion circuit 16 then connect with HDMI conversion circuit 17, while micro-computer unit (MCU) 18 is connected with HDMI conversion circuit 17 by a I2C interface 181, HDMI conversion circuit 17 then is connected with HDMI output port 12, such that the HDMI conversion circuit 17 can output the converted video and audio signals of HDMI TMDS signal format from HDMI output port 12.

By the above described construction, in using the present invention, the USB connection port 11 is firstly connected to the USB interface port 21 of said computer main frame 20, the computer main frame 20 then outputs USB packet form video-audio signal, then, said video-audio signal is divided into video signal and audio signal by the USB Hub circuit 14, wherein, the video signal is converted to 12/24 bit RGB format by USB to 12/24-bit RGB format output circuit 15, and then transmitted to HDMI conversion circuit 17 via a 12/24 bit bus; while the audio signal is converted into S/PDIF or I2S format, and then is transmitted to HDMI conversion circuit 17, then through 12C interface 181, the micro-computer unit (MCU) 18 controls HDMI conversion circuit 17 to combine video signal of 12/24 bit format and audio signal of S/PDIF or 12S format and convert them into HDMI format signal, after that, the HDMI format signal is outputted from HDMI output port.

As such, if a HDMI television 30 is connected to said HDMI output port 12, then the television 30 can broadcast the voice and image simultaneously. By the function of simultaneously broadcasting the voice and image, people can easily catch the version of broadcasting. At the same time, the version of broadcasting has the functions of multimedia and high definition of pictures.

Moreover, said main body 10 can be made by plastics and then it is advantageous for light in weight and easy in manufacturing.

In conclusion from above, since the transmitting and conversion apparatus for universal serial bus (USB) to high definition multimedia interface (HDMI) of present invention is not disclosed previously and it does not have been disclosed anywhere, therefore, it is believed to be an invention of novelty. Moreover, the unique character and ability of present invention are more advanced, it is then believed that the present invention is an invention with progressiveness, and meets the requirement of present application according to relevant patent law.

Although the present invention has been described with a certain degree of particularity, the present disclosure has been made by way of example and changes in details of structure may be made without departing from the spirit thereof.

What is claimed is:

1. A transmitting and conversion apparatus for universal serial bus (USB) to high definition multimedia interface (HDMI), it comprises a main body, at one end of the main body, there is a USB connection port for connecting with the USB interface port of a computer frame, the another end of the main body then has a HDMI output port; characterized in that:
in the main body, there is a USB interface, a USB Hub circuit, a USB to 12/24-bit RGB format output circuit, a USB audio signal conversion circuit, a HDMI conversion circuit and a micro-computer unit (MCU); wherein, the USB interface is connected with USB connection port and USB Hub circuit; the USB Hub circuit is connected simultaneously with USB to 12/24-bit RGB format output circuit and USB audio signal conversion circuit; the USB to 12/24-bit RGB format output circuit and USB audio signal conversion circuit then connect with HDMI conversion circuit, while micro-computer unit (MCU) is connected with HDMI conversion circuit by a I2C interface, HDMI conversion circuit then is connected with HDMI output port, such that the HDMI conversion circuit can output the converted video and audio signals of HDMI TMDS signal format from HDMI output port; in using, the USB connection port is firstly connected to the USB interface port of said computer main frame, the computer main frame then outputs USB packet form video-audio signal, then, said video-audio signal is divided into video signal and audio signal by the USB Hub circuit, wherein, the video signal is converted to 12/24 bit RGB format by USB to 12/24-bit RGB format output circuit, and then transmitted to HDMI conversion circuit via a 12/24 bit bus; while the audio signal is converted into S/PDIF or I2S format, and then is transmitted to HDMI conversion circuit, then through I2C interface, the micro-computer unit (MCU) controls HDMI conversion circuit to combine video signal of 12/24 bit format and audio signal of S/PDIF or I2S format and convert them into HDMI format signal, after that, the HDMI format signal is outputted from HDMI output port.

2. The transmitting and conversion apparatus for universal serial bus (USB) to high definition multimedia interface (HDMI) as claimed in claim 1, wherein the main body is manufactured by plastics.
